(19) United States
(12) Patent Application Publication
(10) Pub. No.: US 2007/0235381 A1
(43) Pub. Date: Oct. 11, 2007

(54) Water filter

(76) Inventor: Jackie Tsai, Tali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/397,699

(22) Filed: Apr. 5, 2006

(51) Int. Cl. B01D 27/02

(52) U.S. Cl. 210/287; 210/290

(57) ABSTRACT

A water filter is disclosed to include a housing formed of a top cover shell and a bottom cover shell, and a filter element mounted in the housing for filtrating water passing through the housing, the filter element containing nanosilver fabrics, nanocarbon fibers, calcium sulfite, KDF-55, and coconut shell active carbon.

### BACKGROUND OF THE INVENTION

1. Field of the Invention

The present invention relates to water filters and more particularly, to such a water filter, which is practical for use as a shower filter to effectively remove harmful substances from shower water.

2. Description of the Related Art

Water is one of the requisite elements for the life of human beings. People may not pay much attention to environmental protection while searching for economic growth. Industrial and home waste water may be discharged to the outside without treatment intendedly or accidentally causing contamination to the environment. It is well known that our drinking water may contain many harmful substances and chemical pollutants such as germs, virus, heavy metals, bleaching agent, agricultural pesticides, and etc. Boiling drinking water may remove some germs and chlorine, however it cannot remove certain germs, heavy metals and agricultural pesticides. Various water filters are commercially available. However, these water filters cannot effectively remove all harmful substances from water.

FIGS. 14˜17 show a water filter according to the prior art. According to this design, the water filter 9 is connectable to a faucet 8 to filtrate water passing out of the faucet 8, comprising a body 91, a bottom cap 93 capped on the bottom side of the body 91, and a filter element 92 mounted in the bottom cap 93. The filter element 92 has a perforated plate 921 covered on the top side and a wire gauze filter 912 covered on the bottom side. This design of water filter 9 can simply remove solid matters greater than a certain size.

Further, poisonous substances may pass from showering water through the skin into the body when one is showering. People normally care about the quality of drinking water but pay little attention to the invisible harmful substances and germs in showering water. However, conventional shower filters cannot effectively remove germs and other invisible poisonous substances from showering water.

Therefore, it is desirable to provide a water filter that eliminates the aforesaid problems.

### SUMMARY OF THE INVENTION

The present invention has been accomplished under the circumstances in view. It is the main object of the present invention to provide a water filter, which effectively removes odor, chlorine, chlorinated hydrocarbons, hydrogen sulfide, iron, and heavy metals like lead, arsenic, aluminum, mercury and cadmium from your water. It is another object of the present invention to provide a water filter, which is practical for use as a shower filter to remove harmful substances from showering water.

To achieve these and other objects of the present invention, the water filter comprises a top cover shell, the top cover shell having a water inlet disposed at a top side thereof, and an inner thread disposed at a bottom side thereof; a bottom cover shell, the bottom cover shell having an outer thread disposed at a top side thereof and threaded onto the inner thread of the top cover shell, a water outlet disposed at a bottom side thereof, a rubber seal ring sealed between the bottom side of the top cover shell and the top side of the top cover shell; and a filter element mounted inside the top cover shell and the bottom cover shell.

Further, the filter element comprises: (a) nanosilver fabrics; (b) nanocarbon fibers; (c) calcium sulfite; (d) KDF-55; and (e) coconut shell active carbon.

### BRIEF DESCRIPTION OF THE DRAWINGS

FIG. 1 is an exploded view in section of a water filter in accordance with a first embodiment of the present invention.

FIG. 2 is an elevational exploded view of the water filter according to the first embodiment of the present invention.

FIG. 3 is a schematic drawing showing an application example of the first embodiment of the present invention.

FIG. 4 is a schematic drawing showing another application of the first embodiment of the present invention.

FIG. 5 is an exploded view of a water filter in accordance with a second embodiment of the present invention.

FIG. 6 is a sectional view of the second embodiment of the present invention, showing the water filter in action.

FIG. 7 is an elevational exploded view of the water filter according to the second embodiment of the present invention.

FIG. 8 is an oblique elevation of the water filter according to the second embodiment of the present invention.

FIG. 9 is an oblique bottom elevation of the top cover shell of the water filter according to the second embodiment of the present invention.

FIG. 10 is a sectional plain view of the bottom cover shell of the water filter according to the second embodiment of the present invention.

FIG. 11 is a schematic drawing showing an application example of the water filter according to the second embodiment of the present invention.

FIG. 12A is an exploded view of a water filter in accordance with a third embodiment of the present invention.

FIG. 12B is an exploded view of a part of FIG. 12A.

FIG. 13 is an elevational view of the water filter according to the third embodiment of the present invention.

FIG. 14 is a schematic drawing showing a conventional water filter installed in the water outlet of a faucet.

FIG. 15 is an exploded view of the water filter shown in FIG. 14.

FIG. 16 is an oblique elevation in an enlarged scale of the filter element of the water filter shown in FIG. 15.

FIG. 17 is a bottom view of the filter element shown in FIG. 16.

### DETAILED DESCRIPTION OF THE PREFERRED EMBODIMENT

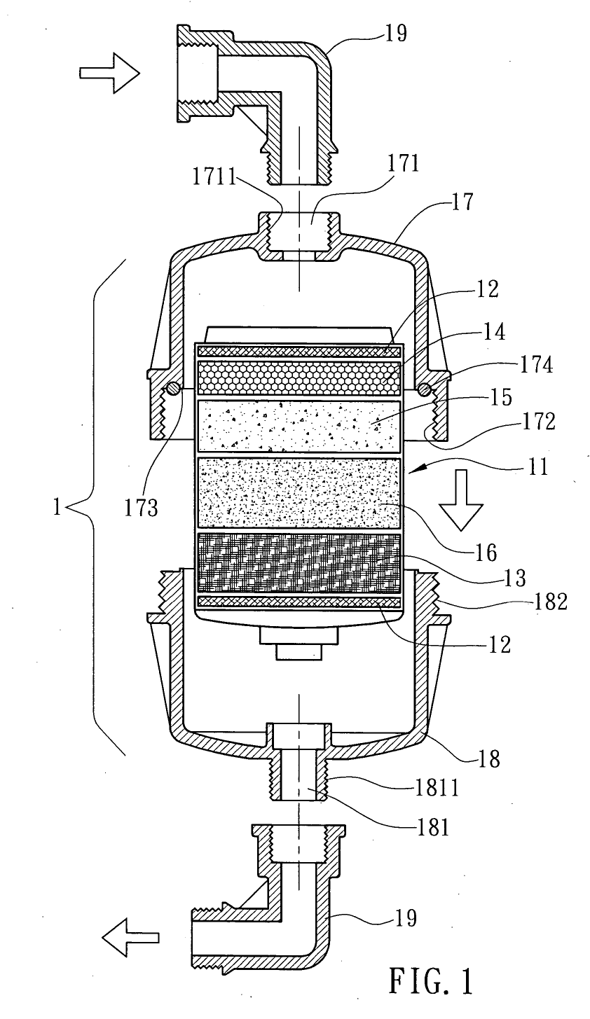

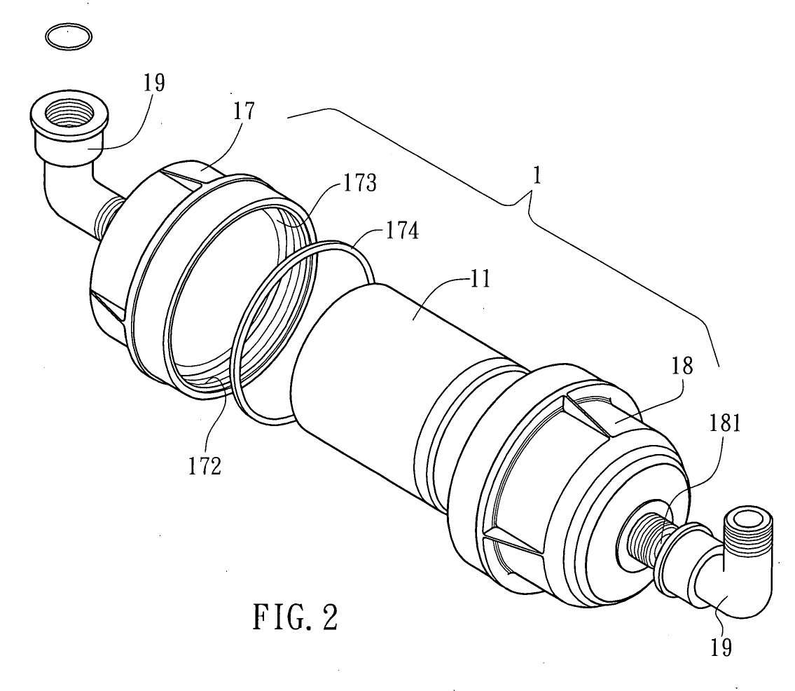

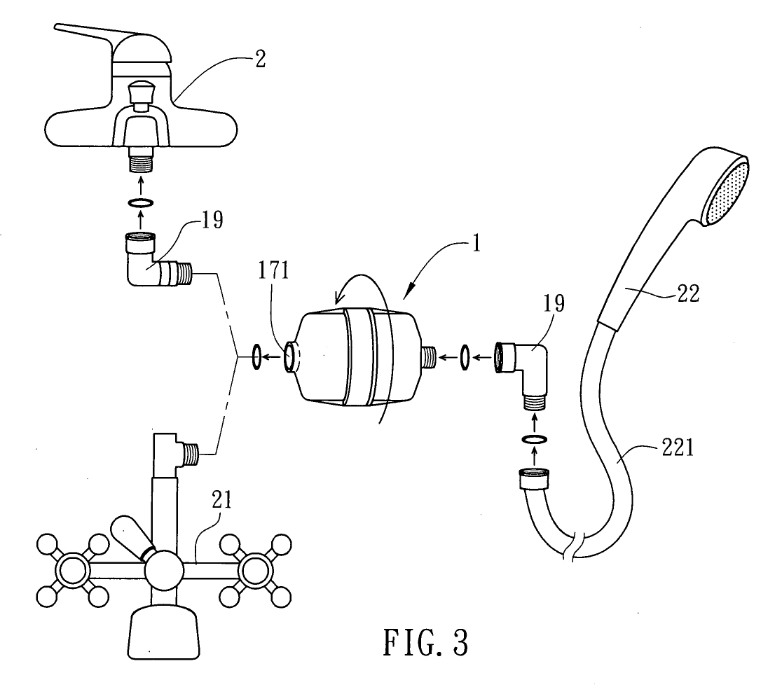

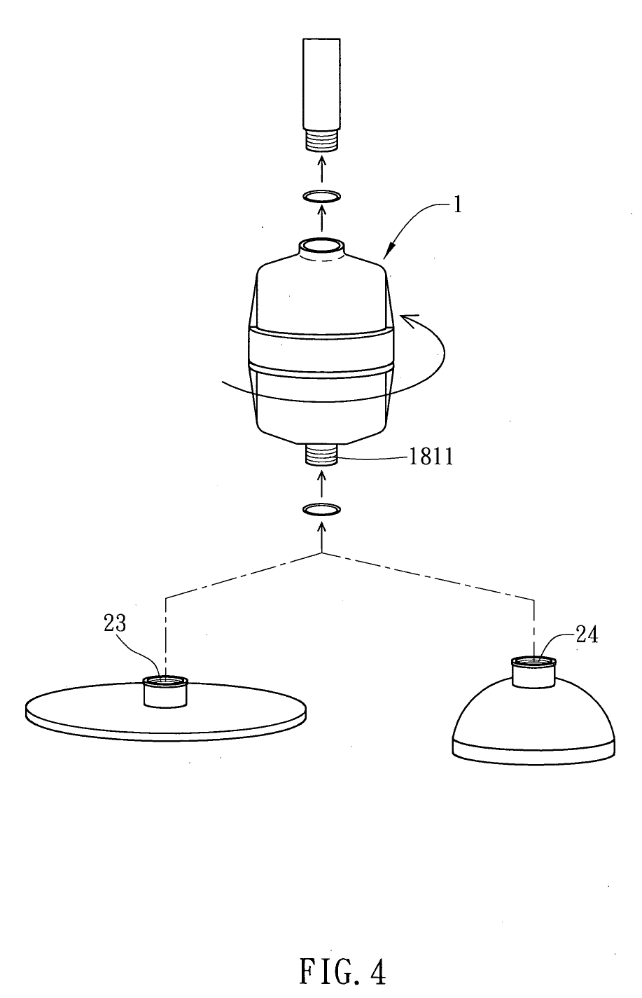

Referring to FIGS. 1 and 2, a water filter 1 in accordance with a first embodiment is shown. According to this embodiment, the water filter 1 is a shower filter comprising a top cove shell 17, a bottom cover shell 18, and a filter element 11 mounted in the holding space defined within the top cover shell 17 and the bottom cover shell 18. The top cover shell 17 has a water inlet 171 at the top side and an inner thread 172 at the bottom side. The bottom cover shell 18 has a water outlet 181 at the bottom side, and an outer thread 182 at the top side. The outer thread 182 of the bottom cover shell 18 is threaded into the inner thread 172 of the top cover shell 17. A water seal ring 174 is mounted on a step 173 inside the top cover shell 17 and stopped against the top edge of the bottom cover shell 18 to seal the gap. Two pipe connectors 19 are respectively threaded into the inner thread 1711 in the water inlet 171 and threaded onto the outer thread 1811 on the water outlet 181 to connect the water inlet 171 to a faucet 2 or 21 and to connect the water outlet 181 to the hose 221 of a shower 22 respectively (see FIG. 3). Alternatively, the outer thread 1811 of the water outlet 181 can be directly connected to a city water supply port 23 or 24 (see FIG. 4).

The filter element 11 comprises a layer of nanosilver fabrics 12, a layer of nanocarbon fibers 13, a layer of calcium sulfite 14, a layer of KDF-55 filter material 15, and a layer of coconut shell active carbon 16. The characteristics and effects of the filter materials of the filter element 11 are outlined hereinafter.

1. Nanosilver Fabrics

The layer of nanosilver fabrics is prepared by coating fabrics with a layer of nanoscaled silver coating by means of sputtering deposition. Silver ions can freely pass through the cell membranes of bacteria to destruct the cell membranes and to join sulfa amino enzyme of protease, thereby lowering the activity of enzyme and blocking its biochemical synthesis power. Therefore, the layer of nanosilver fabrics effectively kills germs without loss of silver ions. After killed on germ, silver ions are released from the dead germ and go to make an oxidation reaction with other organic germs. This action is repeated again and again to kill surrounding germs.

2. Nanocarbon Fibers

Nanocarbon fibers are composed of carbon atoms that are catalyzed by catalyst to form polymeric carbon compound of various structures that are shaped like a solid or hollow cylinder having thermal and electric conductive characteristics and the characteristics of light mass, high chemical stability, high aspect ratio, and high structural strength. Nanocarbon fibers/nanometered bamboo charcoal/nanometered bamboo charcoal fibers can remove odor, sterilizing chloride, agricultural pesticides and many other harmful chemical pollutants, and heavy metals (lead, cadmium, mercury, arsenic) from water.

3. Calcium Sulfite

Calcium sulfite is used as chloride expeller or antioxidant. When calcium sulfite is reacted with chloride ion, calcium chloride and sulfite ion produced. Calcium sulfite is mainly to remove chloride ion from water. Calcium sulfite reacts with chloride ion to produce chloride ion and sulfite ion. The chemical equation is as follows:
Cl₂(g)+S)₃²⁻(aq)+H₂O(I)−>2Cl(aq)+SO₄²⁻(aq)+2H⁺(aq)
Calcium sulfite is a product obtained from the reaction of calcium oxide with sulfur dioxide, and the related chemical equation is: CaO(s)+SO₂(g)−>CaSO₃(s)
4. KDF-55 Filter Material

DF-55 filter media is a patented, high purity alloy of copper and zinc. It eliminates contaminants from water using electrochemical oxidation-reduction, also known as redox potential. KDF-55 uses the redox principle to effectively remove chlorine, chlorinated hydrocarbons, hydrogen sulfide, iron, and heavy metals like lead, arsenic, aluminum, mercury and cadmium from your water.

5. Coconut Shell Active Carbon

Coconut shell active carbon effectively removes ethylene dichloride, bleaching agent, agricultural pesticides, chlorine, bad smell, bad coloring, fluorine, and chemical organic pollutants from your water.

By means of the aforesaid filter materials, the filter element 11 of the shower filter effectively removes harmful substances from shower water. The order filter materials of the filter element 11 may be arranged subject to actual requirements. Because the filter element 11 is set inside the top cover shell 17 and the bottom cover shell 18, it can easily be replaced.

Further, other materials may be used to substitute for the filter materials of the filter element 11 as follows:
1. Nanometered silver grains may be used to substitute for nanosilver fabrics.
2. Nano bamboo charcoal or nano bamboo charcoal fibers may be used to substitute for nanocarbon fibers.
3. Farinfrared mineral grains may be used to substitute for or mix with calcium sulfite.
4. KDF-85, KDF-F, KDF-C, KDF Process Mediums may be used to substitute for KDF-55.
5. Active carbon or cation exchange resin may be used to substitute for coconut shell active carbon. Cation exchange resin effectively removes heavy metal ions (calcium and magnesium ions) from water, and converts hard water into soft water.

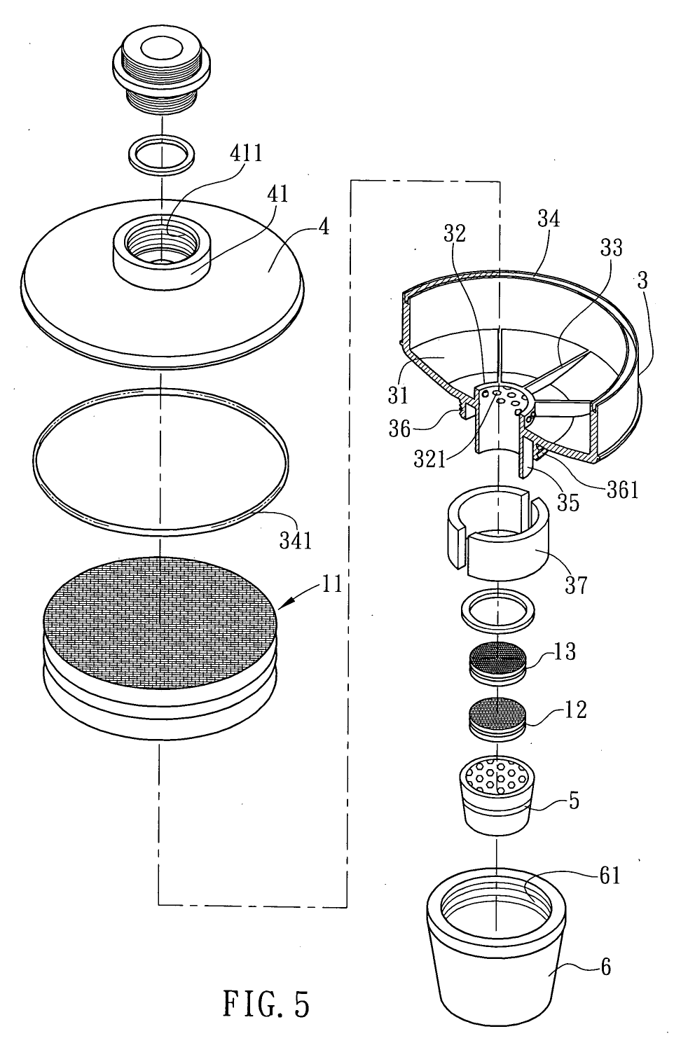

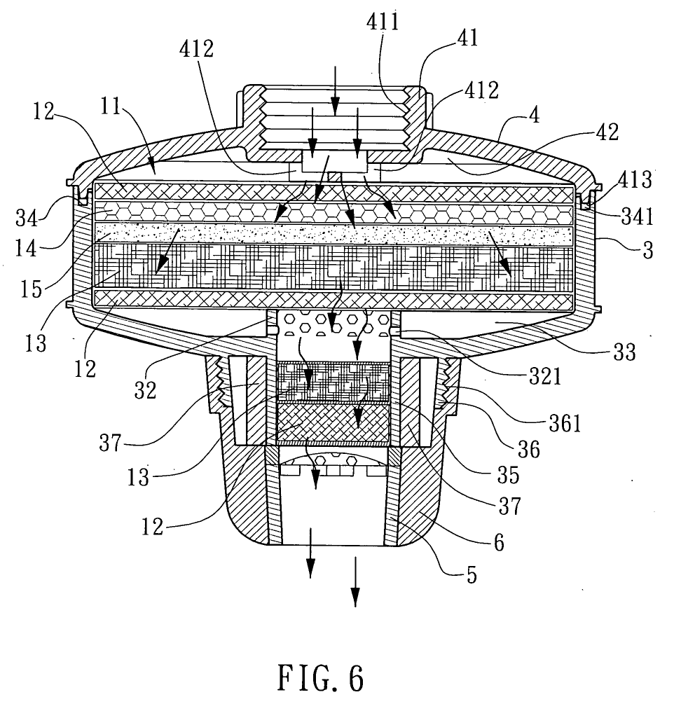

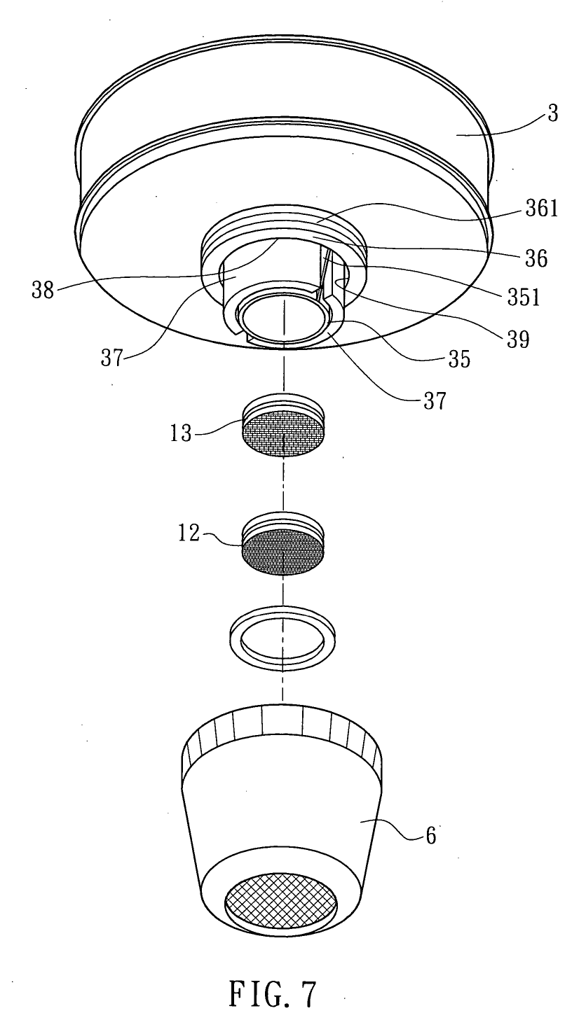

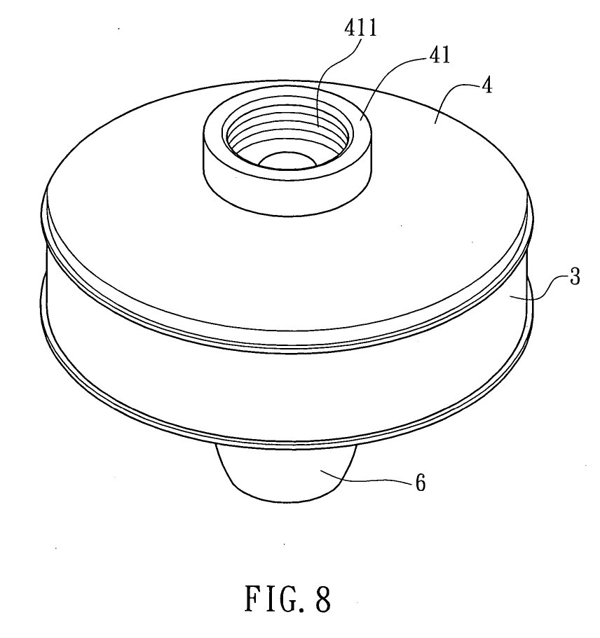

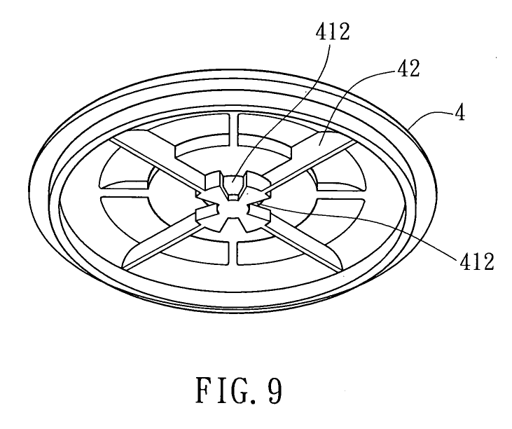

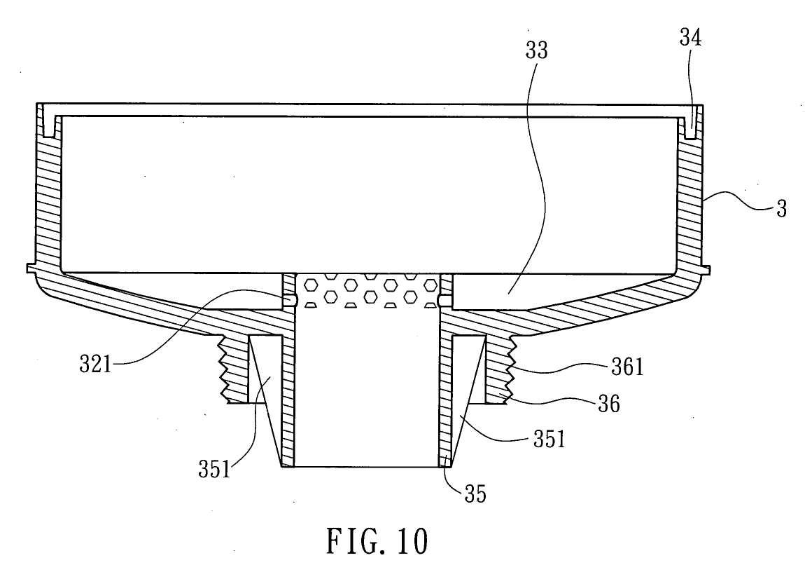

Referring to FIGS. 5˜11, a water filter in accordance with a second embodiment of the present invention is shown comprising a bottom cover shell 3, a filter element 11 mounted inside the bottom cover shell 3, and a top cover shell 4 covered on the top side of the bottom cover shell 3. The bottom cover shell 3 has an accommodation open chamber 31, a bottom tube 35 downwardly extending from the center of the accommodation open chamber 31, tubular inside flange 32 vertically connected to the bottom tube 35 in a line and suspending inside the accommodation open chamber 31, a plurality of transverse through holes 321 cut through the peripheral wall of the tubular inside flange 32, a plurality of radial flow guides 33 formed integral with the bottom wall of the accommodation open chamber 31 and respectively radially arranged around the center hole 32, a grooved rim 34 holding a rubber seal ring 341, a coupling sleeve 36 downwardly extending from the bottom wall and coaxially suspending around the bottom tube 35, an outer thread 361 extending around the periphery of the coupling sleeve 36, and a partition member 351 connected between the bottom tube 35 and the coupling sleeve 36 and dividing the space between the bottom tube 35 and the coupling sleeve 36 a first chamber 38 and a second chamber 39. The filter element 11 is accommodated in the accommodation open chamber 31 of the bottom cover shell 3. Similar to the aforesaid first embodiment, the filter element 11 comprises a layer of nanosilver fabrics 12, a layer of nanocarbon fibers 13, a layer of calcium sulfite 14, a layer of KDF-55 filter material 15, and a layer of coconut shell active carbon 16. The top cover shell 4 is fastened to the bottom cover shell 3 and pressed on the rubber seal ring 341, having a tubular center flange 41, an inner thread 411 extending around the inside wall of the tubular center flange 41 for fastening to a faucet 7 (see FIG. 11), a plurality of water inlets 412 formed on the bottom side of the tubular center flange 41, a plurality of radial flow guides 42 formed integral with the bottom wall around the water inlets 412, and a bottom coupling flange 413 coupled to the grooved rim 34 of the bottom cover shell 3 and pressed on the rubber seal ring 341. Further two smoothly arched magnets 37 are respectively mounted in the first chamber 38 and the second chamber 39 between the bottom tube 35 and the coupling sleeve 36. The magnetic lines of force of the magnets 37 cut and magnetize the flow of water passing therethrough. The magnetic energy of the magnetic field produced by the magnets 37 activates water molecules. Further, a spout 6 is capped on the coupling sleeve 36 to hold a supplementary filter element 5 in the bottom tube 35. The spout 6 has an inner thread 61 threaded onto the outer thread 361 of the coupling sleeve 36. Further, a supplementary filter element 5 is accommodated in the spout 6. Further, an additional layer of nanosilver fabrics 12 and an additional layer of nanocarbon fibers 13 may be set in the bottom tube 35 on the top side of the supplementary filter element 5.

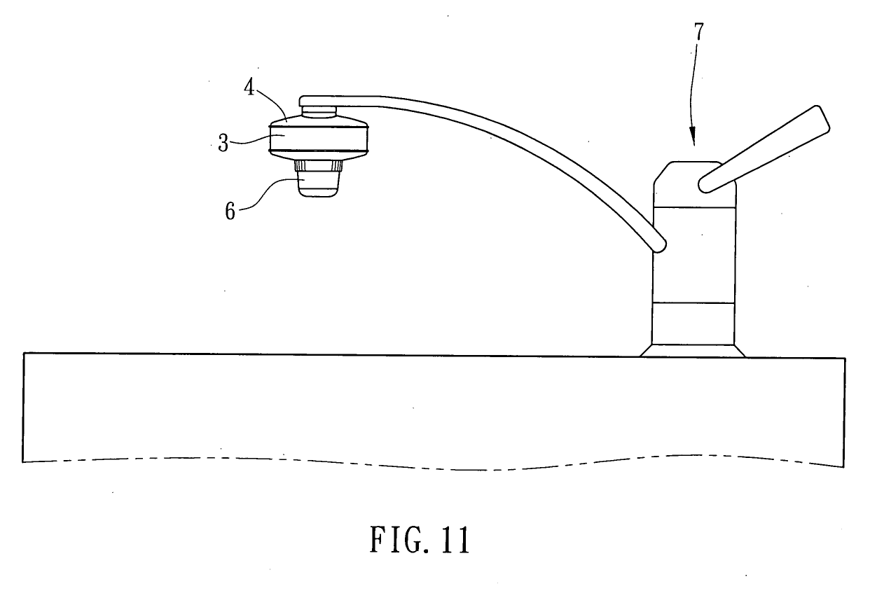

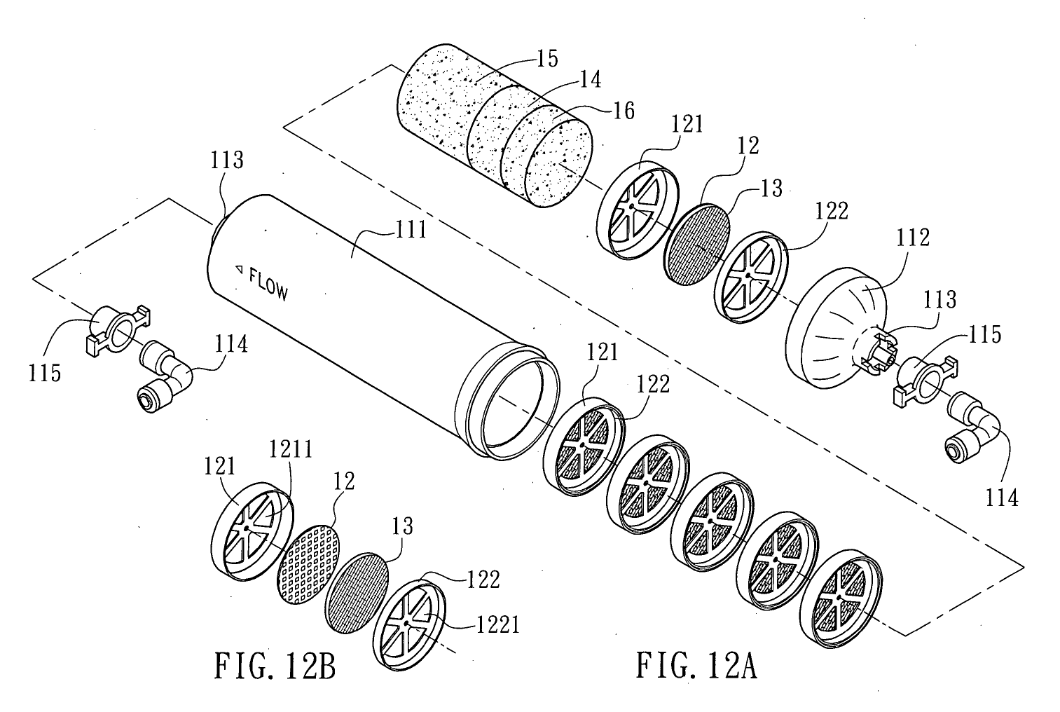

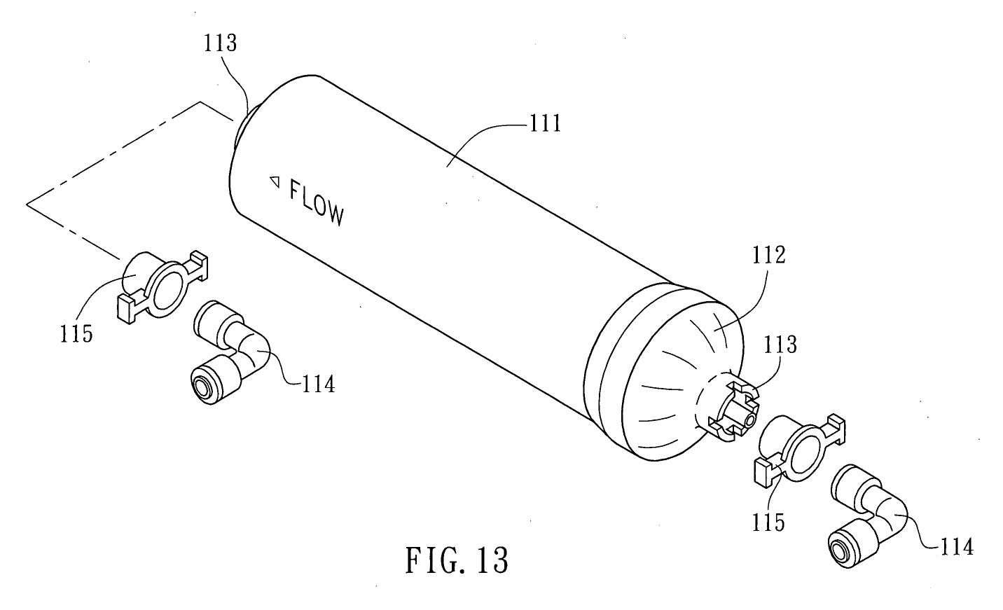

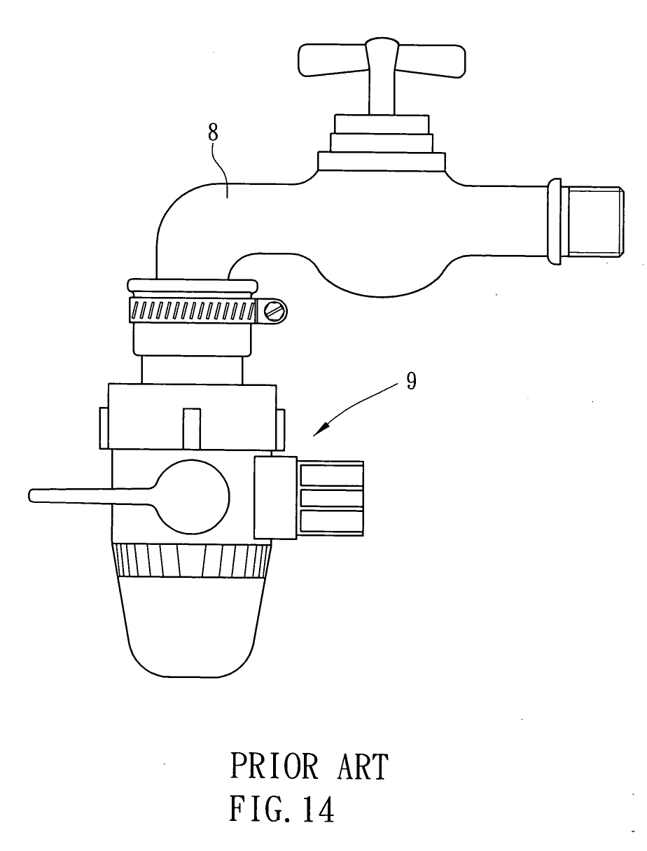

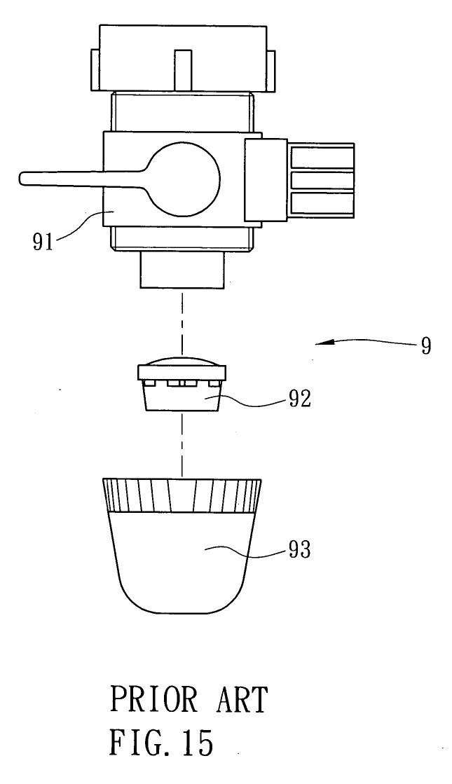

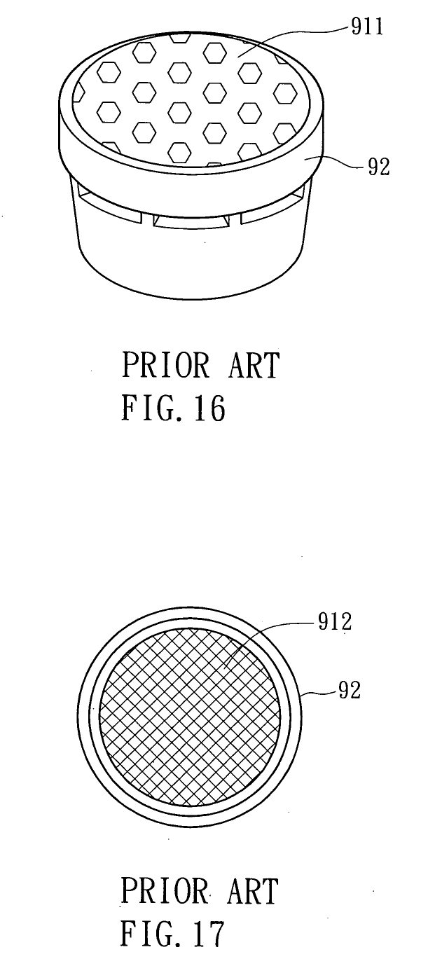

Referring to FIGS. 12A, 12B and 13, a water filter in accordance with a third embodiment is shown comprising a cylindrical casing 111, a cap 112 covered on the top end of the cylindrical casing 111, two connectors 113 respectively provided at the center of the cap 112 and the center of the bottom end of the cylindrical casing 111, two bents 114 respectively connected to the connectors 113 with fittings 115 for connecting the water filter to water supply pipes, and a plurality of filter materials including nanosilver fabrics 12, nanocarbon fibers 13, calcium sulfite 14, KDF-55 15, and coconut shell active carbon 16. Further, spacer members 121 and 122 that have through holes 1211 and 1222 are set in between the filter materials.

What the invention claimed is:

1. A water filter comprising:
a top cover shell, said top cover shell having a water inlet disposed at a top side thereof, and an inner thread disposed at a bottom side thereof;
a bottom cover shell, said bottom cover shell having an outer thread disposed at a top side thereof and threaded onto the inner thread of said top cover shell, a water outlet disposed at a bottom side thereof,
a rubber seal ring sealed between the bottom side of said top cover shell and the top side of said top cover shell; and
a filter element mounted inside said top cover shell and said bottom cover shell.

2. The water filter as claimed in claim 1, wherein said filter element comprises:
(a) nanosilver fabrics;
(b) nanocarbon fibers;
(c) calcium sulfite;
(d) KDF-55; and
(e) coconut shell active carbon.

3. The water filter as claimed in claim 1, wherein said filter element comprises:
(a) nanometered silver grains;
(b) nanocarbon fibers;
(c) calcium sulfite;
(d) KDF-55; and
(e) coconut shell active carbon.

4. The water filter as claimed in claim 1, wherein said filter element comprises:
(a) nanosilver fabrics;
(b) nanocarbon charcoal/nanocharcoal fibers;
(c) calcium sulfite;
(d) KDF-55; and
(e) coconut shell active carbon.

5. The water filter as claimed in claim 1, wherein said filter element comprises:
(a) nanosilver fabrics;
(b) nanocarbon fibers;
(c) far infrared mineral grains;
(d) KDF-55; and
(e) coconut shell active carbon.

6. The water filter as claimed in claim 1, wherein said filter element comprises:
(a) nanosilver fabrics;
(b) nanocarbon fibers;
(c) calcium sulfite;
(d) KDF-85/KDF-F/KDF-C/KDF Process Mediums; and
(e) coconut shell active carbon.

7. The water filter as claimed in claim 1, wherein said filter element comprises:
(a) nanosilver fabrics;
(b) nanocarbon fibers;
(c) calcium sulfite;
(d) KDF-55; and
(e) active carbon/cation exchange resin.

8. The water filter as claimed in claim 1, wherein said water inlet is mounted with pipe connector means connectable to a shower hose.

9. The water filter as claimed in claim 1, wherein said water outlet is mounted with connector means connectable to a faucet.

10. A water filter comprising:
a bottom cover shell, said bottom cover shell having an accommodation open chamber, a bottom tube downwardly extending from the center of said accommodation open chamber, tubular inside flange vertically connected to said bottom tube in a line and suspending inside said accommodation open chamber, a plurality of transverse through holes cut through the peripheral of said tubular inside flange, a coupling sleeve coaxially suspending around said bottom tube, and an outer thread extending around the periphery of said coupling sleeve for mounting;
a filter element accommodated in said accommodation open chamber of said bottom cover shell;
a top cover shell fastened to said bottom cover shell to cove said accommodation chamber, said top cover shell having a tubular center flange connectable to a faucet, and a plurality of water inlets formed on said tubular center flange; and
a spout threaded onto the outer thread of said coupling sleeve.

11. The water filter as claimed in claim 10, wherein said filter element comprises:
(a) nanosilver fabrics;
(b) nanocarbon fibers;
(c) calcium sulfite;
(d) KDF-55; and
(e) coconut shell active carbon.

12. The water filter as claimed in claim 10, further comprising at least one secondary filter means mounted in said bottom tube of said bottom cover shell.

13. The water filter as claimed in claim 12, wherein said at least one secondary filter means comprises at least two different water filter materials.

14. The water filter as claimed in claim 10, wherein said bottom cover shell has a plurality of radial flow guides formed integral with a bottom wall of said accommodation open chamber.

15. The water filter as claimed in claim 10, wherein said top cover shell has a plurality of radial flow guides formed integral with a bottom wall thereof around said water inlets.

16. The water filter as claimed in claim 10, further comprising a partition member connected between the bottom tube coupling sleeve of said bottom cover shell and dividing the space between the bottom tube coupling sleeve of said bottom cover shell a first chamber and a second chamber, and two magnets respectively mounted in said first chamber and said second chamber.

17. The water filter as claimed in claim 10, further comprising a supplementary filter element mounted in said spout.

18. The water filter as claimed in claim 10, wherein said bottom cover shell has a grooved top rim and a rubber seal rim mounted ins aid grooved top rim; said top cover shell has a bottom mounting flange engaged into said grooved top rim of said bottom cover shell and pressed on said rubber seal ring.

19. A water filter comprising:
a cylindrical casing, said cylindrical casing having a top open end and a bottom close end;
a cap covering the top open end of said cylindrical casing;
two connectors respectively provided at said cap and the close bottom end of said cylindrical casing for connecting said cylindrical casing between two water pipes for guiding water through said cylindrical casing; and
a plurality of filter materials mounted inside said cylindrical casing, said filter materials including nanosilver fabrics, nanocarbon fibers, calcium sulfite, KDF-55, and coconut shell active carbon.
